(19) United States
(12) Patent Application Publication
(10) Pub. No.: US 2022/0061328 A1
(43) Pub. Date: Mar. 3, 2022

(54) ANTIVIRAL METAL TREATMENTS FOR FIBER SUBSTRATES, FILTER MEDIA HAVING ANTIVIRAL METAL TREATMENTS, AND PROCESSES FOR TREATING FIBER SUBSTRATES

(71) Applicant: UOP LLC, Des Plaines, IL (US)

(72) Inventors: James M. Hodges, Evanston, IL (US); Robert L. Bedard, McHenry, IL (US); F. Stephen Lupton, Evanston, IL (US); Dennis F. van der Vliet, Skokie, IL (US); Mana Moarrefzadeh, Wheeling, IL (US); Hayim Abrevaya, Kenilworth, IL (US); Jon E. Ball, Crystal Lake, IL (US); Erin M. Broderick, Arlington Heights, IL (US); Paula L. Bogdan, Mount Prospect, IL (US)

(21) Appl. No.: 17/403,097

(22) Filed: Aug. 16, 2021

Related U.S. Application Data
(60) Provisional application No. 63/141,239, filed on Jan. 25, 2021.
(60) Provisional application No. 63/071,860, filed on Aug. 28, 2020.

(51) Int. Cl. A01N 59/20; A01N 59/16; A01N 25/08; A01N 25/34; A01P 15/00

(52) U.S. Cl. CPC A01N 59/20; A01N 59/16; A01P 15/00; A01N 25/34; A01N 25/08

(57) ABSTRACT

Processes for increasing a viricidal activity of a fiber substrate. The fiber substrate is provided. The fiber substrate may comprise acidic functional groups and may be acid leached to provide additional acidic groups. Metal ions may thereafter be exchanged with a proton from the acidic functional groups. A divalent metal is introduced to the fiber substrate. An antiviral metal is introduced and deposited onto the fiber substrate by galvanic displacement. Subsequently, a further antiviral metal is introduced and deposited on the fiber substrate by an electroless process. The treated fiber substrate is washed and dried. The deposition of antiviral metals onto the fiber substrate to form a treated fiber substrate may occur before or after the fiber substrate is incorporated into a filter media in a wet-laid paper making process.

### RELATED APPLICATIONS

This application claims priority to U.S. Provisional Patent Application Ser. No. 63/071,860 filed on Aug. 28, 2020 and claims priority to U.S. Provisional Patent Application Ser. No. 63/141,239 filed on Jan. 25, 2021 the entireties of both of which are incorporated herein by reference.

### FIELD OF THE INVENTION

This invention relates generally to depositing antiviral metals on glass fibers, and more particularly to impart increased viricidal activity of the fibers compared to an untreated fiberglass filter substrate, as well as a method of depositing such an antiviral metal.

### BACKGROUND OF THE INVENTION

The SARS-CoV-2 coronavirus, known as “Covid-19”, has created a global pandemic resulting in enormous numbers of stricken persons requiring hospitalization and, in many cases, resulting in death of the stricken person. Accordingly, the unforeseen pandemic has highlighted the need for physical or chemical agent that are capable of deactivating or destroying viruses like the Covid-19 virus.

Coronaviruses are a group of viruses that usually cause mild illnesses, such as the common cold. However, certain types of coronavirus can infect the lower airway, causing serious illnesses like pneumonia or bronchitis. Most people get infected with coronaviruses at some point in their lives and the majority of these infections are harmless. Covid-19 is a notable exception.

Coronaviruses have extraordinarily large single-stranded RNA genomes—approximately 26,000 to 32,000 bases or RNA “letters” in length. Coronavirus particles are surrounded by a fatty outer layer called an envelope and usually appear spherical, as seen under an electron microscope, with a crown or “corona” of club-shaped spikes on their surface.

Accordingly, the unforeseen pandemic has highlighted the result need for physical or chemical agent that are capable of deactivating or destroying viruses like the COVID-19 virus.

High-Efficiency Particulate Air (HEPA) filtration and Ultra-Low

Particulate Air (ULPA) filtration may be used to remove particles from the air. The ULPA standard requires removal of 99.9995% of particles down to 1.2 micrometers. Both HEPA and ULPA filters consist of innumerable tiny strands of randomly arranged glass microfibers, typically alkali borosilicate glass compositions for HEPA and low boron compositions for ULPA in cleanroom applications.

Fiberglass wet-laid media is found in high-pressure hydraulic filtration, because the glass fibers are non-compressible and provide excellent dirt-holding capacity. Fiberglass fiber can be made quite fine, even sub-micron in diameter, and is the material of choice for HEPA filters for clean rooms, coalescing media, airliner and other ECS (environmental control systems), hospital and other health care air filtration, and certain laboratory filters.

Although existing glass HEPA filter media is known to effectively remove infectious agents such as viruses from air, most existing media have not been rendered viricidal. It is difficult to incorporate the metal ions into fiberglass and cellulose substrates without negatively effecting the particle removal properties.

Antiviral metal ions are usually deposited on glass via an ion exchange, often in molten salt media, followed by a high temperature heat treatment to initiate solid state ion exchange and diffusion of the active metal ion into the glass. The resulting glass articles are typically used for anti-viral glass surfaces for touchpads, laptop computers, and smart phone screens, however this process is not compatible with manufacture of micro-glass fibers used in air filtration.

It is difficult to incorporate the viricidal materials into fiberglass and cellulose substrates without adversely affecting the performance of such material as a filter media. Accordingly, there remains a need for effective and efficient processes for treating fiber-based substrates, such as fiberglass and cellulose, to create an anti-viral surface that can be incorporated into papermaking.

### SUMMARY OF THE INVENTION

The present invention provides new methods for treating fiber substrates, such as fiberglass filter media, with a viricidal treatments having metal ions. The present processes introduce a reducing ionic species to the acidic ionic exchange sites of the fiber substrate, followed by treatment of the fiber with one or more antiviral metal ions. The one or more antiviral metal ions are deposited onto the surface of the fiber substrate via galvanic displacement and/or an electroless process to provide a uniform treatment of antiviral metal ions. Prior to introduction of the reducing ionic species, the fiber substrate may be optionally subjected to an acid leaching step to produce acid ion exchange sites. This acid leaching step is optionally especially for more chemically reactive glasses with designed biosolubility characteristics, and in some cases in more conventional glass compositions with higher levels of alkali in the composition such as in B-, or C-glass microfibers. Depending on the process uses to the deposit the antiviral metal, the fiber can have up to 5.0wt % of the antiviral metal deposited thereon.

The present antiviral metal treatment can be advantageously accomplished in the wet end of a media paper machine in a mixing tank prior to the headbox, in the headbox shortly before wet laying on a moving forming fabric, or subsequent to wet-laying before, during, or after the addition of binder resins to the formed media and prior to drying. This would make sure the viricidal metal ion is present in the ionic form at the very surface that contacts viral particles during use and is believed to be the most active version for viricidal properties of the anti-viral metal element.

Therefore, the present invention may be characterized, in at least one aspect, as providing a process for increasing a viricidal activity of a fiber substrate by: providing the fiber substrate; introducing the fiber substrate to a divalent metal solution to deposit divalent metals from the divalent metal solution on the fiber substrate; introducing the fiber substrate to an antiviral metal salt to form a treated fiber substrate in which antiviral metal from the antiviral metal salt is deposited on the fiber substrate by reduction as a result of oxidation of the divalent metals deposited on the fiber substrate; and, drying the treated fiber substrate; wherein the reduced antiviral metal is present on the treated fiber substrate in an amount between about 0.0001 wt. % and about 5.0 wt. % of the treated fiber substrate.

A second aspect of the invention is a process for increasing a viricidal activity of a fiber substrate by: providing the fiber substrate; introducing the fiber substrate to a solution comprising a divalent metal salt; introducing the fiber substrate to a solution comprising a first antiviral metal salt, the first antiviral metal salt comprising a first antiviral metal; introducing a reducing agent; and introducing a second antiviral metal salt in an alkaline solution to form a treated fiber substrate, the second antiviral metal salt comprising a second antiviral metal; and wherein a viricidal activity of the treated fiber substate is higher than a viricidal activity of the fiber substrate, wherein the antiviral metal is present in an amount between about 0.0001 wt. % and about 5.0 wt. % of the treated fiber substrate.

A third aspect of the invention is a filter media substrate having viricidal activity comprising the filter media substrate treated with one or more antiviral metals, wherein the filter media substrate comprises a fiber substrate, wherein the one or more antiviral metals are selected from the group consisting of silver, copper, zinc, bismuth, tin, nickel, iron, and combinations thereof, and wherein the one or more antiviral metals are present in an amount between about 0.0001 wt. % and about 5.0 wt. % of the filter media substrate.

A fourth aspect of the invention is a filter media comprising a fiber substrate having an antiviral treatment, wherein the antiviral treatment comprises the steps of: (a) providing the fiber substrate; (b) introducing the fiber substrate to a divalent metal solution; (c) introducing the fiber substrate to an antiviral metal salt to form a treated fiber substrate; and wherein an antiviral metal of the antiviral metal salt is reduced by a divalent metal of the divalent metal solution, and the divalent metal is oxidized; and wherein the antiviral metal is present in an amount ranging from about 0.0001 to about 5.0 wt. % of the antiviral fiber substrate.

A fifth aspect of the invention is a filter media comprising a fiber substrate having an antiviral treatment, wherein the antiviral treatment comprises the steps of: (a) providing the fiber substrate; (b) introducing the fiber substrate to a solution comprising a divalent metal salt; (c) introducing the fiber substrate to a solution comprising a first antiviral metal salt, the first antiviral metal salt comprising a first antiviral metal; (d) introducing a reducing agent; and (e) introducing a second antiviral metal salt in an alkaline solution to form a treated fiber substrate, the second antiviral metal salt comprising a second antiviral metal; and wherein a viricidal activity of the treated fiber substate is higher than a viricidal activity of the fiber substrate, and, wherein the antiviral metal is present in an amount ranging from about 0.0001 to about 5.0 wt. % of the antiviral fiber substrate.

Additional aspects, embodiments, and details of the invention, all of which may be combinable in any manner, are set forth in the following detailed description of the invention.

### DETAILED DESCRIPTION OF THE DRAWINGS

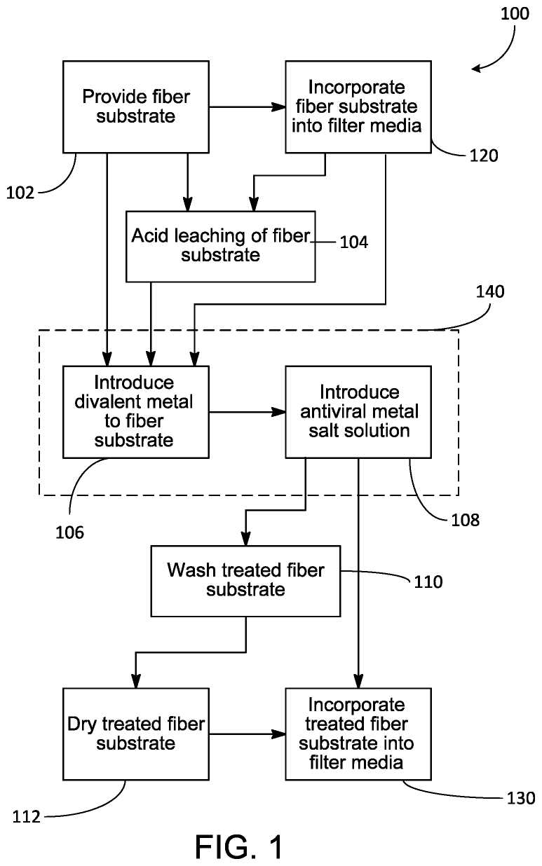

One or more exemplary embodiments of the present invention will be described below in conjunction with the following drawing figures, in which FIG. 1 shows a process according to an embodiment of the galvanic displacement process of the present invention.

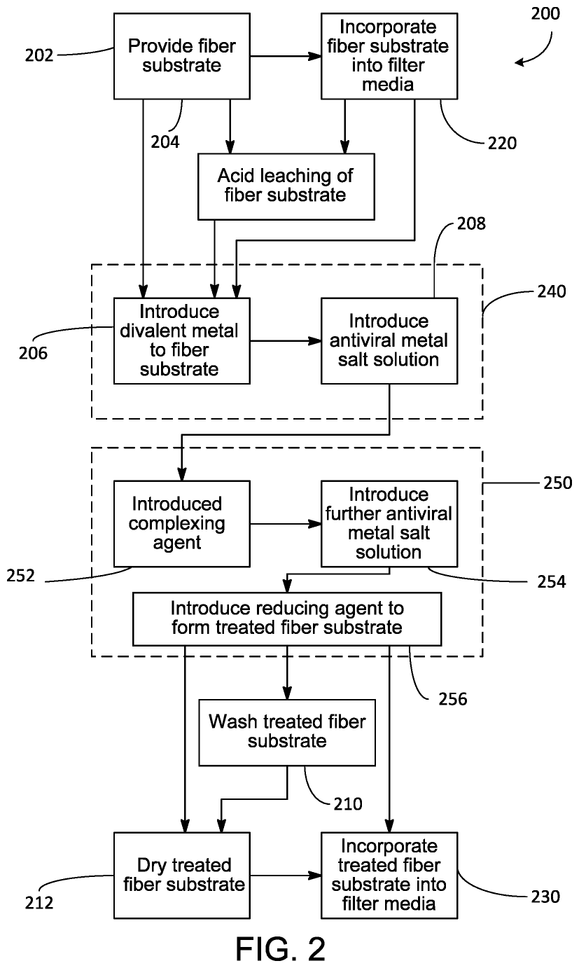

FIG. 2 shows a process according to an embodiment of the electroless plating process of the present invention.

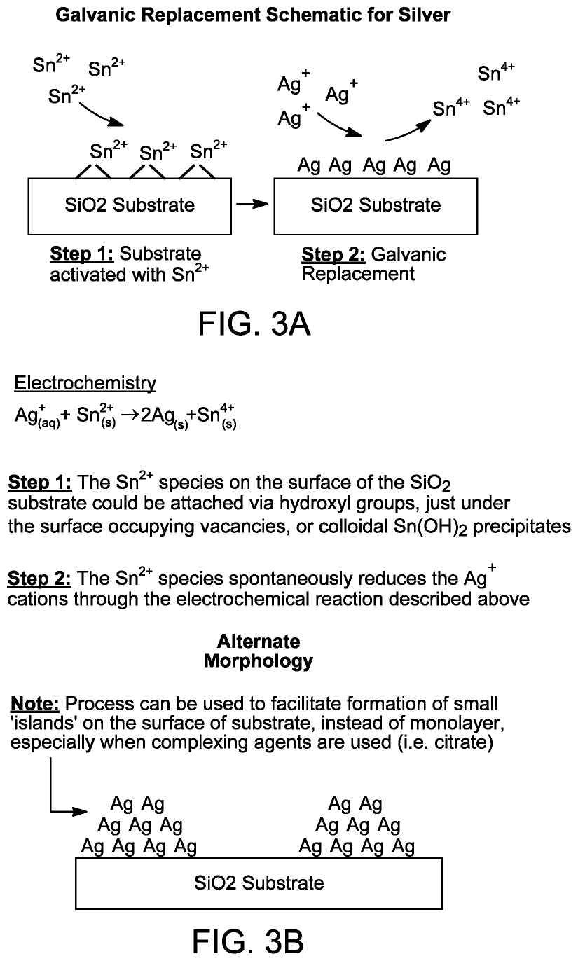

FIGS. 3A and 3B show an embodiment of treating a fiber substrate with silver in an embodiment of the galvanic displacement process.

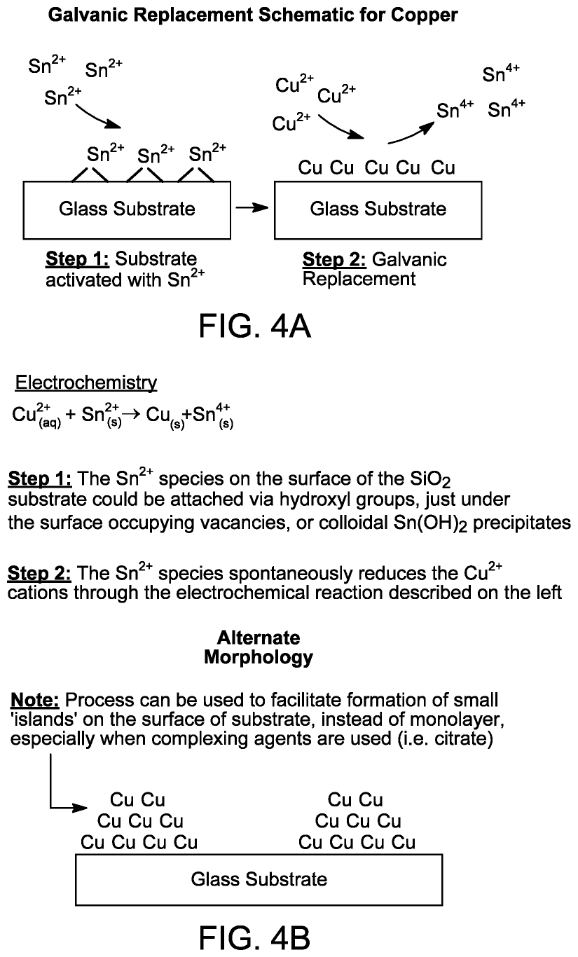

FIGS. 4A and 4B show an embodiment of treating a fiber substrate with copper in an embodiment of the galvanic displacement process.

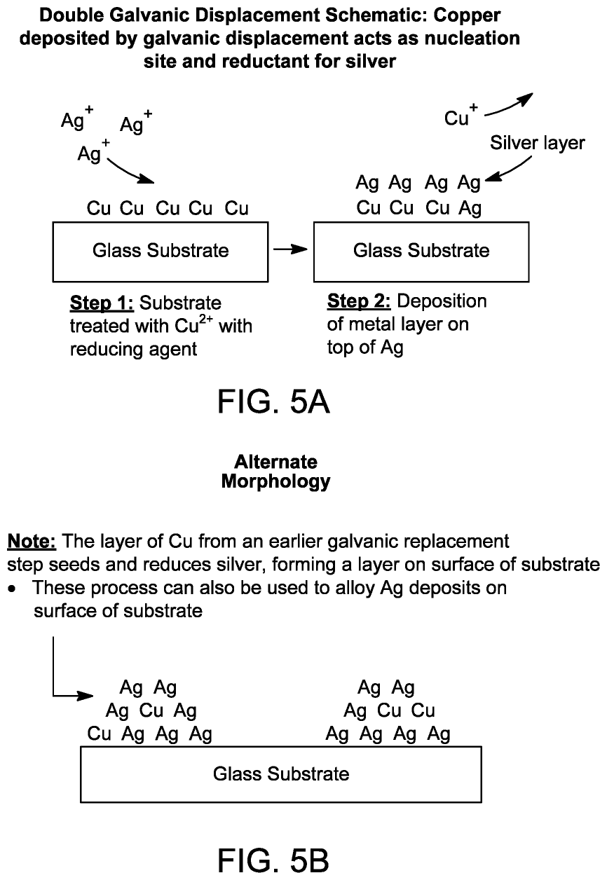

FIGS. 5A and 5B show an embodiment of treating a fiber substrate with copper and silver in an embodiment of a double galvanic displacement process.

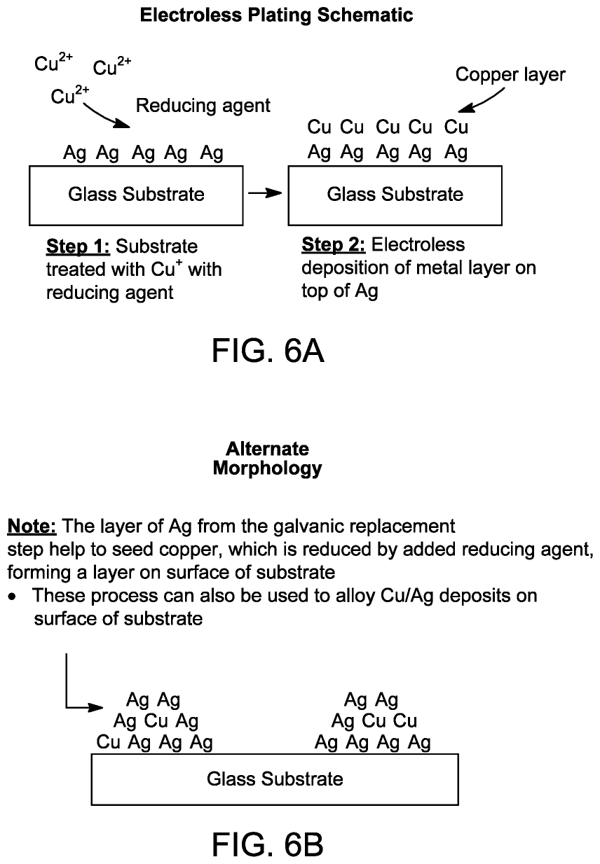

FIGS. 6A and 6B show an embodiment of treating a fiber substrate with silver in an embodiment of the galvanic displacement process and treating the fiber substrate with copper using the electroless plating process.

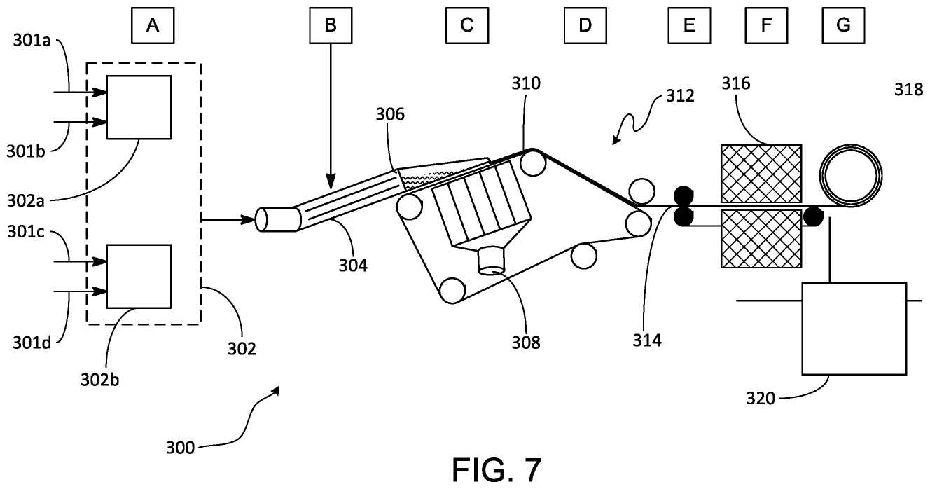

FIG. 7 shows a papermaking process according to an embodiment of the present invention.

### DETAILED DESCRIPTION OF THE INVENTION

As mentioned above, the present processes create an antiviral surface on a flexible substrate. The antiviral surface is created by a process that can include pre-generated acidic ionic exchange sites that subsequently have had the proton of the acid and/or residual exchangeable alkali cations exchanged with a reducing ionic species, such as Sn²⁺, followed by displacement of the Sn²⁺ by a suitable reduced metal species such as Ag, Cu, or Zn. This treatment may be preferably carried out on hydrophilic substrates (filters, cloths, wet-laid media, other surfaces of interest), although hydrophobic surfaces may also be treated by suitable modifications known in the art. Compared with an untreated fiber substrate, the treated fiber substrate is believed to have increased viricidal properties.

Specifically, the present invention provides a novel approach for depositing antiviral metals onto various substrates, especially fiberglass and cellulose, which are anti-viral materials that can be integrated into existing HEPA and other high efficiency filter technologies. Moving forward, anti-viral HEPA and other high efficiency filters are predicted to play an important role in ensuring the safety of employees, customers, and students as they return to indoor environments. Importantly, the technology or process resulting from this invention is amenable with existing fiber and papermaking technologies and can readily be scaled-up to meet the demands of manufacturers. The process can be used to deposit a wide variety of metals including Ag, Cu, Zn, and Bi, among others.

The present application describes methods for depositing anti-viral metals onto a variety of substrates used in paper-making processes, especially glass microfibers. These processes may employ a galvanic displacement process, where divalent tin (Sn²⁺) is incorporated into the surface of the chosen substrate, and the substrate is then treated with a solution containing the chosen metal ion (Ag⁺, Cu⁺, etc.).

The divalent tin reduces the metal cation, forming a metallic deposit via galvanic displacement and the residual oxidized tin (Sn⁴⁺) substantially dissolves into the treatment solution. The process is compatible with a variety of substrate-metal combinations and is anticipated to easily integrate into existing wet-laid media-manufacturing processes. Such a treated glass surfaces are believed to be beneficial in the fight against many viruses, including the SARS-CoV-2 virus. With a galvanic displacement process, it is believed up to 2.5 wt % of the antiviral metal may be deposited. Additionally, the present processes may also include an electroless plating process which uses a reducing agent to replace metal ions on the surface of the fiber with an antiviral metal. With an electroless plating process, it is believed up to 5.0 wt % of the antiviral metal may be deposited.

With these general principles in mind, one or more embodiments of the present invention will be described with the understanding that the following description is not intended to be limiting.

The present deposition processes can be divided into two types: galvanic displacement and autocatalytic (electroless) deposition.

Galvanic displacement or immersion plating has a mechanism different from that of autocatalytic deposition. In immersion plating, reducing agents are not required because the base materials can behave as the reducing agent. Galvanic displacement takes place when the ion incorporated into the surface of the material, which occurs in the first step of the process, is displaced by a metallic ion in the solution having a lower oxidation potential than the displaced metal ion. As a sequence, the ion deposited onto the surface in the first step is typically released back into the solution, and the metallic ions in the solution are reduced on the surface of the base material.

In electroless plating (a type of autocatalytic deposition), reduction of metallic ions in the solution and film deposition can be carried out using a reducing agent, which becomes oxidized during the process. When this reducing agent is at a defined temperature, which depends on the reducing agent and bath composition, it can spontaneously oxidize and free electrons for the reduction of metallic ions. Thus, it is named autocatalytic because oxidation of the reducing agent can start or become self-sustained only on the deposited metal surface.

### Galvanic Displacement

As shown in FIG. 1, a first embodiment process 100 includes six main steps: providing a fiber substrate 102; conducting an optional acid leaching step 104; introducing a divalent metal to the fiber substrate 106; introducing an antiviral metal salt solution 108; washing the antiviral substrate 110; and drying the substrate 112. These steps will be described below, with the understanding that terms (such as “first,” “second,” “third,” and “fourth,” etc.) do not imply a specific order and that one should not be inferred unless expressly stated. The galvanic displacement process 140 is shown in FIG. 1. Also, the fiber substrate can be incorporated into filter media before deposition of the antiviral metal 120 or after the deposition of the antiviral metal on the fiber substrate 130.

### Fiber Substrate

In the first step 102 in the depicted process 100, the fiber substrate is provided. The fiber substrate includes a fiber typically used in filter media such a fiberglass or cellulose. In a particular embodiment, the fiber substrate is a borosilicate glass.

The fibers 10 may be any type of fiber typically used in filter media such as fiberglass or cellulose. For example, the fiber substrate may be A-glass fiber, C-glass fiber, D-glass fiber, E-glass fiber, ECR glass fiber, T-glass fiber, S2-glass fiber, M-glass fiber, and mixtures thereof. A biosoluble glass such as a low Al₂O₃ glass with high B₂O₃, and either a high Na₂O+K₂O content or high CaO+MgO content.

For example, the fiber substrate may be an A-glass, a B-glass, a C-glass, or a biosoluble glass such as a low Al₂O₃ glass with high B₂O₃, and either a high Na₂O+K₂O content or high CaO+MgO content. In a preferred embodiment, the fiber substrate is a B- or C-glass borosilicate or a bio-soluble microglass glass such as Johns Manville 475, 253, 481, or 902 glass or C-04-F and B-04-F glass microfibers manufactured by Unifrax Specialty Fibers.

C-04-F comprises approximately 63.0-67.0 SiO₂; 4.0-7.0 B₂O₃; 14.0-17.0 Na₂O; and 3.0-5.0 Al₂O₃. B-04-F comprises approximately 55.0-60.0 SiO₂; 8.0-11.0 B₂O₃; 9.5-13.5 Na₂O; and 4.0-7.0 Al₂O₃. JM 481 glass microfibers comprise approximately 60.8 wt. % SiO₂; 11.4 wt. % B₂O₃; 9.1 Na₂O; and 2.0 Al₂O₃.

The fiber substrate may be provided in a dry form, in suspension, or otherwise dispersed in a liquid medium.

### Acid Leaching

In the second step 104 of the process 100, an optional acid leaching is performed. The glass microfibers may first be treated with an acid in an acid leaching step. This step may be useful for fiberglass substrate with a low porosity and/or low specific surface area. In an exemplary embodiment, nitric acid is used to exchange cations of the fiber substrate with protons. However, in other embodiments any strong acid could be used, including hydrohalic acids such as HF or HCl. Alternatively, it is also contemplated that or carboxylic acids such as acetic acid are used for the acid leaching step 104. The acid leaching step 104, if used, can be carried out in a stirred tank just prior to the headbox of the paper machine followed by decanting the leachate and re-suspending the glass fibers in water prior to pumping the fiber furnish to the headbox.

The acid leaching step 104 is effective to remove sodium, potassium, and aluminum from at or near the surface of the fiber substrate to provide vacancies for the divalent metal and the antiviral metal.

### Introducing Divalent Metal

In the third step 106 of the process 100, a divalent metal, which may include tin, palladium, nickel, cobalt, iron, and zinc, is introduced to the fiber substrate followed optionally by decanting or filtering the spent solution from the treated fibers prior to additional steps. In an exemplary embodiment, a divalent metal ion of tin (Sn²⁺) is introduced to the fiber substrate via a divalent metal salt as tin (II) chloride dehydrate (SnCl₂-2H₂O). In other embodiments, other divalent metal salts may be used.

The divalent metals are deposited onto the surface of the fiber substrate. In the illustrated embodiment, tin (II) is deposited onto the surface of the glass fibers, preferably in the vacancies provided by the acid leaching step. See, FIG. 3A.

### Introducing Antiviral Metal

Turning to the fourth step 108 in the present process 100, a first antiviral metal is introduced to the fiber substrate followed optionally by decanting or filtering the spent solution from the treated fibers prior to additional steps. The antiviral metal is deposited onto the fiber substrate via galvanic displacement. This process is shown in detail in FIGS. 3A and 3B.

The step of introducing the antiviral metal to the fiber substrate may utilize any existing surface modification processes, such as by dipping the substrate in the antiviral metal salt solution, brushing the antiviral metal salt solution onto the substrate, or by spraying the antiviral metal salt solution onto the substrate. These processes are known in the art.

Overall, the metals that are being increasingly considered for antimicrobial agents are typically transition metals of the d-block (Co, Ni, Cu, Zn, Ag,) and a few other metals and metalloids from groups 13-16 of the periodic table (Ge, Se, Sn, Sb, and Bi).

Preferably the treatment can be accomplished by adding the antiviral metal salt ion exchange solution to the paper machine headbox at an effective time 0 to 60 minutes prior to the wet-laying the glass fiber media. Another preferred treatment operation is the pumping or spraying of the antiviral metal ion exchange solution just after the wet-laid glass media is formed on the forming fabric, at one or more points just before, in combination with resin binder addition, or just after the resin binder is added. These processes are known in the art of papermaking.

The manner and mechanism of attachment may differ depending on the characteristics of the antiviral metal and the fiber substrate. For example, in some cases, the antiviral metal may bond to the fiber substrate. In some cases, the antiviral metal may become entangled in fibers in the fiber substrate.

The exact process of the antiviral metal attaching to the substrate is not important provided that the antiviral metal salt solution is secured for a commercially suitable amount of time (that may differ for different materials).

### Washing Step

The fifth step 110 in the process 100 is washing the antiviral fiber substrate. In the illustrated embodiment, the washing step is performed with hydrochloric acid. In other embodiments, other acids or water may be used in the washing step.

### Drying

The sixth step 112 in the process 100 is drying the treated substrate. In this step, the suspension medium evaporates, leaving the fiber substrate and unattached metal ions to attach to the surface of the substate and provide a dry, treated substrate.

Drying may occur by infrared radiation or between heated rollers. In an exemplary embodiment, drying the treated fiber substrate takes place at a temperature between about 50° C. and about 150° C.

Optionally, the washing and drying steps 110, 112 may be omitted. As shown in process 100, the galvanic displacement reaction may be followed by incorporating the treated fiber substrate into filter media at step 130. It is contemplated that the fiber substrate is incorporated into filter media before deposition of the antiviral metal 120 or after the deposition of the antiviral metal on the fiber substrate 130. Additionally, the galvanic displacement process 100 may be followed by an electroless deposition of a further antiviral metal onto the fiber substrate (described below). See, FIGS. 6A and 6B.

### Electroless Process

As shown in FIG. 2, a second embodiment of a process 200 includes nine main steps: providing a fiber substrate 202; conducting an optional acid leaching and washing step 204; introducing a divalent metal to the fiber substrate 206; introducing an antiviral metal salt solution 208; introducing a complexing agent 252; introducing a further antiviral metal salt solution, introducing a reducing agent; washing the antiviral substrate 110; and drying the substrate 112. These steps will be described below, with the understanding that terms (such as “first,” “second,” “third,” and “fourth,” etc.) do not imply a specific order and that one should not be inferred unless expressly stated.

In the depicted process 200, a galvanic displacement process 240 is followed by an electroless process 250 (followed optionally by decanting or filtering the spent solution from the treated fibers prior to additional steps). Those portions of the process 200 that are similar to the ones in the process of FIG. 1 are shown with the same reference numbers increased by “100”, i.e., “102” in FIG. 1 is “202” in FIG. 2.

The electroless process 250 comprises introducing a complexing agent 252, introducing a further antiviral metal salt solution 254, and introducing a reducing agent 256.

### Introduce Complexing Agent

The fifth step in the process 200, which is the first step of the electroless process 252, is introducing a complexing agent 252 followed optionally by decanting or filtering the spent solution from the treated fibers prior to additional steps. The complexing agent is introduced to keep the metal ions in solution. In the illustrated embodiment, ethylenediaminetetraacetic acid (EDTA) and tartaric acid are used. In other embodiments, other known complexing agents, including chelating agents, may be used.

### Introduce Second Antiviral Metal

In the case of a desire for the presence of two reduced metals in the anti-viral treatment, it is preferred that the more noble element is deposited first by one or both deposition methods (galvanic and electroless) followed by electroless deposition of the less noble metal. The “noble-ness” of each metal with respect to each other can be determined by the relative reduction potentials of each, with the metal with the less negative (more positive) reduction potential being more “noble”. TABLE 1, below, shows the relative reduction potentials for various metals.

TABLE 1

| Reduction reaction | E^{O} |
|---|---|
| Fe²⁺(aq) + 2e⁻→ Fe(s) | −0.45 |
| Co²⁺(aq) + 2e⁻ → Co (s) | −0.28 |
| Ni²⁺(aq) + 2e⁻ → Ni (s) | −0.26 |
| Sn⁴⁺(aq) + 2e⁻ → Sn²⁺(aq) | +0.15 |
| Cu²⁺(aq) + 2e⁻ → Cu(s) | +0.34 |
| Ag⁺(aq) + e⁻ → Ag(s) | +0.80 |
| Pd²⁺(aq) + 2e⁻ → Pd (s) | +0.95 |
| Pt²⁺(aq) + 2e⁻ → Pt (s) | +1.18 |
| Au³⁺(aq) + 3e⁻→ Au (s) | +1.50 |

The sixth step 112 in the process 200, which is the second step of the electroless process 250, is introducing a further metal salt solution followed optionally by decanting or filtering the spent solution from the treated fibers prior to additional steps. In an exemplary embodiment, the second antiviral metal is introduced by a further antiviral metal salt, such as copper sulfate.

As stated above, in the antiviral treatment by these processes, it would be preferred to deposit silver first followed by electroless deposition of copper. Thus, the second antiviral salt may be copper sulfate. In other embodiments, other antiviral metal salts may be used.

### Introduce Reducing Agent

In the seventh step 256 in the process 200, the third step of the electroless process 250, a reducing agent is added followed optionally by decanting or filtering the spent solution from the treated fibers prior to additional steps. In the illustrated embodiment, glyoxylic acid is used, however, this is merely exemplary. Additionally, exemplary reducing agents that may be suitable for the present processes include, but are not limited to, glyoxylic acid, oxalic acid, glycolic acids, glucose, formaldehyde, hydrazine, sodium borohydride, and combinations thereof. It should be appreciated that whether or not something is a “reducing agent” will depend on the molecule to be reduced. Species and molecules that are considered to be possible or suitable reducing agents include hydroxides, molecules with multiple —OH groups, like sugars such as glucose, fructose, sucrose, aldehydes, or other polyols. In the presence of the reducing agent, the second antiviral metal is reduced and deposited on the surface of the fiber, while the reducing agent is oxidized.

Although FIG. 2 illustrates that the electroless process 250 follows the galvanic displacement process 240, this is merely preferred, and it is contemplated that the electroless process 250 is the only process used to apply antiviral metals onto the fiber substrate.

FIG. 3A illustrates an embodiment of the galvanic displacement process wherein the divalent metal is tin (II) and the antiviral metal is silver. In step 1 of FIG. 3A, the Sn²⁺ species on the surface of the SiO₂ substrate could be attached via hydroxyl groups, just under the surface occupying vacancies, or colloidal Sn(OH)₂ precipitates. In step 2, the Sn²⁺ species spontaneously reduces the Ag⁺ cations through the following electrochemical reaction:

2Ag_{(aq)}⁺+Sn₍ₛ₎²⁺→2Ag₍ₛ₎+Sn₍ₛ₎⁴⁺

FIG. 3B illustrates an alternate morphology as the treatment is FIG. 3A in which the galvanic displacement process is used to facilitate formation of small ‘islands’ of silver on the surface of substrate, instead of a monolayer, especially when complexing agents are used (i.e. citrate).

FIG. 4A illustrates an embodiment of the galvanic displacement process wherein the divalent metal is tin (II) and the antiviral metal is copper. In step 1 of FIG. 4B, the Sn²⁺ species on the surface of the SiO₂ substrate could be attached via hydroxyl groups, just under the surface occupying vacancies, or colloidal Sn(OH)₂ precipitates.

In step 2, the Sn²⁺ species spontaneously reduces the Cu²⁺ cations through the following electrochemical reaction:

Cu²⁺_{(aq)}+Sn₍ₛ₎²⁺→Cu₍ₛ₎+Sn₍ₛ₎⁴⁺

FIG. 4B illustrates an alternate morphology as the treatment is FIG. 4A in which the galvanic displacement process is used to facilitate formation of small ‘islands’ of copper on the surface of substrate, instead of a monolayer, especially when complexing agents are used (i.e. citrate).

FIG. 5A illustrates an embodiment of the electroless process wherein the first antiviral metal is copper, and the second antiviral metal is silver. In step 1 of FIG. 5A, the glass substrate is treated with Cu²⁺ on or just under the surface occupying vacancies. In step 2, the Ag is deposited over the Cu via a second galvanic displacement that does not proceed to completion. This provides an alloyed deposition of copper and silver. Such an alloy may have enhanced stability on the fiber substrate and/or enhanced antiviral characteristics.

FIG. 5B illustrates an alternate morphology as the treatment is FIG. 5A in which the galvanic displacement process is used to facilitate formation of small ‘islands’ of copper and silver on the surface of substrate, instead of a monolayer, especially when complexing agents are used (i.e. citrate).

FIG. 6A illustrates an embodiment of the electroless process wherein the first antiviral metal is silver, and the second antiviral metal is copper. In step 1, the silver species on the surface of the SiO₂ substrate could be attached via galvanic displacement, on or just under the surface occupying vacancies of the glass substrate. A reducing agent is also provided. In step 2, the Cu²⁺ species reduces in the presence of the reducing agent and is deposited through the electroless process.

FIG. 6B illustrates an alternate morphology as the treatment is FIG. 6A in which a treatment of silver from the galvanic displacement process is used to facilitate formation of small ‘islands’ of silver and copper on the surface of substrate, instead of a monolayer, especially when complexing agents are used (i.e. citrate).

### Papermaking

The steps of incorporating the fiber substrate into filter media 120 and incorporating the antiviral fiber substrate into filter media 130 of the present processes are shown in FIGS. 1 and 2. It is envisioned that the antiviral metal can be deposited onto the fiber substrate to form an antiviral fiber substrate that is subsequently incorporated into filter media, via a wet-laid process. Also, it is envisioned that the fiber substrate is incorporated into filter media, via a wet-laid process, and subsequently the antiviral metal can be deposited onto the fiber substrate to form an antiviral fiber substrate.

FIG. 7 shows an embodiment of the wet-laid process 300. The wet-laid process includes a pre-headbox region A, a headbox region B, a wet-laying region C, a binder region D, a rolling region E, a drying region F, and a post-drying region G. The pre-headbox region comprises a first pre-mix tank 302a and a second pre-mix tank 302b.

In the pre-headbox region A, a first fiber substrate 301a is provided and a first antiviral component 301b is introduced to the fiber substrate in the first pre-mix tank. In the second pre-mix tank 302b a second fiber substrate 301c and a second antiviral component 301d are mixed. In some embodiments the galvanic displacement can occur in the first premix tank. In another embodiment, a galvanic displacement can occur upstream to the first premix tank and an electroless deposition can take place in either the first or second pre-mix tank.

The pre-headbox mixing 302 creates a fiber slurry 304. The fiber slurry is sent to the headbox 306, which is used to apply the fiber slurry to the wet-laid papermaking machine. The wet-laid papermaking machine comprises a suction box 308 to draw liquid out downward and inclined wire 310. Thereafter, binder 312 is applied to the wet-laid fiber. A nip roll press 314 compresses the web, and a dryer 316 removes excess moisture. Thereafter, a roller 318 is used to store the filter media. Post-drying treatment 320 may include further coating or antiviral treatment.

In certain contemplated embodiments, the antiviral metal can be introduced to the fiber substate in the pre-headbox region A, in the headbox region B, in the wet-laying region C, in the binder region D, in the rolling region E, and in the post-drying region G.

Contemplated embodiments include the antiviral metal being introduced to the fiber substrate at various points during the paper-making process. For example the antiviral metal can be introduced to the fiber substrate in one or more of the following unit operations of a paper-making process: a wet-end mix tank, a machine chest, a headbox or binder impregnation section of a paper machine selected from the group consisting of: fourdrinier, twin-wire machine, Rotoformer®, and Delta Former® or other inclined-type paper machines.

It should be appreciated that any suitable method for creating a glass fiber slurry may be used. In some cases, antiviral metals and any additional additives are added to the slurry to facilitate processing. The temperature and pH may also be adjusted to a suitable range. In some embodiments, the temperature and pH of the slurry are maintained. In some cases, the temperature and pH are not actively adjusted.

Additional adjustments to the fiber slurry chemistry may be desired to improve substrate formation in the presence of the increased ionic strength of the antiviral metal galvanic and electroless plating deposition solutions, for example by the addition of charged and/or neutral retention aids such as cationic and anionic polyacrylamide of various charge densities and molecular weight distributions, polyethyleneimine polyelectrolytes, starch, colloidal clays, alumina, and silica, and neutral polyethylene oxide with varying molecular weight distributions known in the art.

In some embodiments, the wet laid process uses similar equipment as a conventional papermaking process, which includes a hydropulper, a former or a headbox, a dryer, and an optional converter. For example, the slurry may be prepared in one or more pulpers. After appropriately mixing the slurry in a pulper, the slurry may be pumped into a headbox, where the slurry may or may not be combined with other slurries or additives may or may not be added. The slurry may also be diluted with additional water such that the final concentration of fiber is in a suitable range.

In some embodiments, the process then involves introducing binder into the pre-formed glass fiber web. In some embodiments, as the glass fiber web is passed along an appropriate screen or wire, different components included in the binder (e.g., soft binder, optional hard binder), which may be in the form of separate emulsions, are added to the glass fiber web using a suitable technique. The one or more antiviral metals may also be appropriately added to the glass fiber web along with the binder or independently from the binder. In some cases, each component of the binder resin is mixed as an emulsion prior to being combined with the other components and/or glass fiber web. The antiviral metals may also be provided as an emulsion prior to mixing with the binder and incorporation into the glass fiber web. In some embodiments, the components included in the binder along with the antiviral metals may be pulled through the glass fiber web using, for example, gravity and/or vacuum. In some embodiments, one or more of the components included in the binder resin and/or the antiviral metals may be diluted with softened water and pumped into the glass fiber web.

In some embodiments, the antiviral metals may be added after the binder and other components have been added. For example, the antiviral metals may be introduced into the glass fiber web in a downstream step after the binder components have already been introduced into the web. In another example, the antiviral metals may be introduced into the glass fiber web along with the binder, or wherein the one or more antiviral metals are added last in the process (e.g., before or after the drying of the fiber web).

After the binder and the antiviral metals are incorporated into the glass fiber web, the wet-laid fiber web may be appropriately dried. In some embodiments, the wet-laid fiber web may be drained. In some embodiments, the wet-laid fiber web may be passed over a series of drum dryers to dry at an appropriate temperature (e.g., about 50° C. to 150° C., or any other temperature suitable for drying). For some cases, typical drying times may vary until the moisture content of the composite fiber is as desired. In some embodiments, drying of the wet-laid fiber web may be performed using infrared heaters. In some cases, drying will aid in curing the fiber web. In addition, the dried fiber web may be appropriately reeled up for downstream filter media processing.

As an example, a filter media may be prepared by a wet laid process where a first dispersion (e.g., a pulp) containing a glass fiber slurry (e.g., glass fibers in an aqueous solvent such as water) is applied onto a wire conveyor in a papermaking machine (e.g., fourdrinier or rotoformer), forming a first phase. A second dispersion (e.g., another pulp) containing another glass fiber slurry (e.g., glass fibers in an aqueous solvent such as water) is then applied onto the first phase. Vacuum is continuously applied to the first and second dispersions of fibers during the above process to remove solvent from the fibers, resulting in a filter media having a first phase and a second phase. The filter media formed is then dried. It can be appreciated that filter media may be suitably tailored not only based on the components of each glass fiber web, but also according to the effect of using multiple glass fiber webs of varying characteristics in appropriate combination. In a contemplated embodiment, one or more of the glass webs contains glass fibers having an antiviral metal treatment.

After formation, the filter media may be further processed according to a variety of known techniques. For example, the filter media may be pleated and used in a pleated filter element. In some embodiments, filter media, or various layers thereof, may be suitably pleated by forming score lines at appropriately spaced distances apart from one another, allowing the filter media to be folded. It should be appreciated that any suitable pleating technique may be used.

It should be appreciated that the filter media may include other parts in addition to the glass fiber web. In some embodiments, the filter media may include more than one glass fiber web. In some embodiments, further processing includes incorporation of one or more structural features and/or stiffening elements. The glass fiber web(s) may be combined with additional structural features such as polymeric and/or metallic meshes. For example, a screen backing may be disposed on the filter media, providing for further stiffness. In some cases, a screen backing may aid in retaining the pleated configuration. For example, a screen backing may be an expanded metal wire or an extruded plastic mesh.

The filter media may be incorporated into a variety of suitable filter elements for use in various applications including ASHRAE filter media applications. The filter media may generally be used for any air filtration application. For example, the filter media may be used in heating and air conditioning ducts. The filter media may also be used in combination with other filters as a pre-filter, such as for example, acting as a pre-filter for high efficiency filter applications (e.g., HEPA). Filter elements may have any suitable configuration as known in the art including bag filters and panel filters.

It should also be appreciated that the critical unit operation steps described in FIGS. 1 and 2 can be applied at various points in the paper making process. In some embodiments, the fibers are treated with divalent cation in a stirred tank upstream from the headbox, and the antiviral metal is added to the fiber slurry in the headbox. In some embodiments, the fibers are treated with divalent cations in the stirred tank upstream from the headbox, and the antiviral metal is subsequently added while the fibers are still in the stirred tank. In yet another embodiment, the fiber is treated with the divalent cation in the upstream tank and/or the headbox, and the antiviral metal is added with the binder resin.

### Antiviral Filter Substrate

It is believed that the present processes increase the viricidal activity of the substrate by providing metal ions at the surface of the fiber substrate in a light, even treatment. Such a surface is believed to be beneficial in the fight against many viruses, including the Covid-19 virus.

Although existing glass HEPA filter media is known to effectively remove infectious agents such as viruses from air, most existing filter media has not been rendered viricidal. Therefore, the infectiousness of virus particles captured in the glass fibers would decay over time, which is several days (recently determined to be about 5 days) on glass surfaces. Existing anti-viral treatments of filtration media tend be thicker coatings which can degrade the particle-capture characteristics, and they are usually multistep processes not readily compatible with paper manufacturing.

A captured virus remaining infectious for 5 days is not ideal in a HEPA filter in a passenger airliner or other human-occupied environment. In the present application, the captured virus particles become non-infectious by their interaction with the antiviral metal treatment. The present antiviral treatments may also minimally modify the flow and particle capture characteristics of the HEPA media while still effectively killing trapped virus particles. The described properties coupled with compatibility of the antiviral treatments with microfiber media wet-laying processes describe the advantages over prior art.

Theories on filtration generally propose multiple particle capture mechanisms that include direct impact of higher momentum particles, attraction by natural forces of smaller, lower momentum particles to fiber surfaces, diffusional, or probabilistic contact of submicron particles with media fibers, and electrostatic forces, with the dominant mechanism being a function of the captured particle size and its electrostatic or surface charge. There is a particle size range that is too small for appreciable momentum effects yet too large for major contributions from diffusion effects. This size range is referred to as the most penetrating particle size (MPPS), which for HEPA media is usually in the 0.3 micron range.

Particle size distribution, for instance from aerosols created by exhaled air, coupled with additional variation of liquid or mucus content of the breathed particles, results in the captured bacteria and viruses-containing particles penetrating HEPA media to different depths as a function of the capture efficiency as described above. Prior art treatments are usually created by spraying the already manufactured HEPA media with coatings of antibacterial and antiviral species. These treatments are concentrated on one or both of the outside surfaces of the media, therefore not effectively interacting with particles that have penetrated into the media beyond the sprayed-on coating. Even antimicrobial coating of premanufactured media by dipping would not be expected to uniformly treat the entire depth of the media since interaction with the first encountered fibers would likely deposit higher quantities of antimicrobial species, thereby similarly creating a non-uniform distribution. In the case of the present invention, a uniform distribution of antibacterial and antiviral species is created through the thickness of the HEPA media, thereby maximizing the antibacterial and antiviral effectiveness of the media throughout the entire range of possible microbe-containing particle size and properties.

The metal-loaded C-glass samples discussed in the examples below were characterized by scanning electron microscopy. Energy Dispersive X-Ray Spectroscopy (EDS or EDX) is a chemical microanalysis technique used in conjunction with scanning electron microscopy (SEM).

Considerable effort went into examining the fibers for agglomerates using backscattering imaging. No agglomerates were found on the Cu or Ag-Cu samples. A single Ag agglomerate of ˜25 nm was found on the Ag-only glass. Though the metal content was confirmed with ICP analyses, the Ag and Cu signals from SEM-EDS were too small for accurate quantitation. Thus, it is inferred that the particles are certainly much less than ˜15 nm and likely ˜2.5 nm or less.

The well-dispersed antiviral metal treatment applied to the glass in the instant disclosure does not provide a thick coating or large agglomerates (e.g., nanoparticles) that would alter the filtration performance of the filter media. Further, the antiviral metal treatment of the instant application is evenly distributed.

In some embodiments, the antiviral treatment will be conducted to achieve various metal loading density ranges in atoms per square nanometer for the fibers. TABLE 2, below, shows the correspondence between metal loading density (atoms/nm²) to wt. % for Ag and Cu treatments on 3.5 m²/g microglass fibers, TABLE 3, below, shows the correspondence between metal loading density (atoms/nm²) to wt. % for Ag and Cu treatments on 1.0 m²/g microglass fibers, and TABLE 4, below, shows the correspondence between metal loading density (atoms/nm²) to wt. % for Ag and Cu treatments on 6.0 m²/g microglass fibers.

TABLE 2

| | atoms/nm² | |
|---|---|---|
| wt. % | Ag | Cu |
| 0.0001 | 0.0016 | 0.0027 |
| 0.001 | 0.016 | 0.027 |
| 0.005 | 0.080 | 0.13 |
| 0.01 | 0.16 | 0.27 |
| 0.5 | 8 | 13 |
| 1 | 16 | 27 |
| 2.5 | 40 | 67 |
| 5 | 80 | 134 |

TABLE 3

| | atoms/nm² | |
|---|---|---|
| wt. % | Ag | Cu |
| 0.0001 | 0.0056 | 0.0095 |
| 0.001 | 0.056 | 0.095 |
| 0.005 | 0.28 | 0.47 |
| 0.01 | 0.56 | 0.95 |
| 0.5 | 28 | 47 |
| 1 | 56 | 95 |
| 2.5 | 140 | 237 |
| 5 | 279 | 474 |

TABLE 4

| | atoms/nm² | |
|---|---|---|
| wt. % | Ag | Cu |
| 0.0001 | 0.00093 | 0.0016 |
| 0.001 | 0.0093 | 0.016 |
| 0.005 | 0.047 | 0.079 |
| 0.01 | 0.093 | 0.16 |
| 0.5 | 4.7 | 7.9 |
| 1 | 9.3 | 16 |
| 2.5 | 23 | 39 |
| 5 | 47 | 79 |

As will be appreciated, the filter media may include fibers of varying diameter and surface area. Accordingly, in some embodiments, the filter media has fibers with an antiviral treatment having a silver loading density range of about 0.0016 to about 80 atoms/nm², preferably between about 0.016 and about 16 atoms/nm². The copper loading density may be in a range of between about 0.0027 and about 134 atoms/nm², preferably between about 0.027 and about 27 atoms/nm². In other embodiments, the filter media has fibers with an antiviral treatment having a silver loading density range of about 0.0056 to about 279 atoms/nm², preferably between about 0.056 and about 56 atoms/nm². The copper loading density may be in a range of between about 0.0095 and about 474 atoms/nm², preferably between about 0.095 and about 95 atoms/nm².

### Antibiotic and Antiviral Testing

Because the enumeration of viruses requires specialized skills and equipment as well exceptionally clean environments to conduct this analysis, bacterial surrogates are often used determine general biocidal efficacy of anti-microbial treatments. This is especially true with the use of vegetative gram-negative bacteria and enveloped viruses which both possess a lipid bilayer cell envelope that is a target for many biocidal agents such as metals and quaternary ammonium compounds. An example of this is Schmidt, Marcel, “Identification of potential bacterial surrogates for validation of thermal inactivation processes of hepatitis A virus.” Master's Thesis, University of Tennessee, 2016. It is generally known that these bacterial surrogates are more resistant to biocides than their viral counterparts so that when efficacy of anti-microbial agents are demonstrated against these surrogates, similar or better anti-microbial activity against corresponding enveloped viruses. For example, disinfectants that show viricidal activity against human coronavirus within 30 seconds require 1 minute of contact time to demonstrate efficacy against a vegetative gram-negative bacterium such as Serratia marcescens. Therefore, the use of bacterial surrogates is a valid approach to ensure biocidal agents are similarly effective against corresponding enveloped viruses.

Compared with the untreated surface of the substrate, the treated substrate is believed to have increased viricidal and/or antibacterial properties by having at least 0.001 wt. % anti viral metal on the fiber substrate.

### EXAMPLES

### Example I: Galvanic Deposition of Ag on Acid-Leached C-Glass

The material described in the first example was generated as follows. First, 16 g of glass microfibers (C-04-F from Unifrax) was added to 4 L of 5.5 weight % aqueous nitric acid solution and heated to 90° C. for 2 hours. The acid-leached sample was then vacuum-filtered using a Buchner funnel, washed with 7.6 L of deionized water, and dried overnight at 110° C. A Sn²⁺ solution was prepared by dissolving 154 mg of SnCl₂-2H₂O in 500 mL of Millipore water, and the acid-leached sample was added and manually stirred for two minutes. The resulting mixture was vacuum-filtered and then washed with 150 mL Millipore water. The resulting filter cake was added to a solution containing 300 mg AgNO₃ dissolved in 500 mL Millipore water and manually stirred for 2 minutes, followed by vacuum filtration. Finally, the filter cake was added to 1 L of Millipore water containing 2 mL of 0.1M HCl solution and manually stirred for two minutes, followed by another filtration and water wash, and then dried at 50° C. overnight.

Two pieces of the resulting filter cake were submitted for ICP elemental analysis, one from the center of the cake and one from the edge. The analysis showed that the piece from the center of the cake had 0.387 wt. % Ag, while the edge of the cake had 0.236 weight % Ag, indicating good homogeneity of the Ag throughout the substrate.

### Example II: Galvanic Deposition of Ag on Untreated C-Glass

The material described in the second example was generated as follows. A Sn²⁺ solution was prepared by dissolving 451 mg of SnCl₂-2H₂O in 1,500 mL of deionized water. 16.5 g of glass microfibers (C-04-F from Unifrax) was added to the solution and stirred with an overhead mixer for 30 minutes. The resulting mixture was vacuum-filtered and then washed with 450 mL Millipore water. The resulting filter cake was added to a solution containing 456 mg AgNO₃ dissolved in 1.5 L of deionized water and stirred with an overhead mixer for 30 minutes, followed by vacuum filtration. Finally, the filter cake was added to 1.5 L of 0.1M HCl solution and stirred for two minutes with an overhead mixer, and then vacuum-filtered, washed with 150 mL of deionized water, and then dried at 50° C. overnight.

The final product was submitted ICP elemental analysis, which indicated the sample had approximately 0.70 weight % Ag.

### Example III: Galvanic Deposition of Ag on Acid-leached B-Glass

The material described in the third example was generated as follows. First, 15 g of glass microfibers (B-04-F from Unifrax) was added to 4 L of 5.5 weight % aqueous nitric acid solution and then heated to 90° C. in an oven for 2 hours. The acid-leached sample was then vacuum-filtered using a Buchner funnel, washed with 7.6 L of deionized water, and dried overnight at 110° C. A Sn²⁺ solution was prepared by dissolving 154 mg of SnCl₂-2H₂O in 1 L of deionized water containing 2 mL of 0.1M HCl solution. 5 g of the acid-leached sample was added and stirred using an overhead mixer for 30 minutes. The resulting mixture was vacuum-filtered and then washed with 500 mL of deionized water. The resulting filter cake was added to a solution containing 0.1 g AgNO₃ dissolved in 1 L deionized water and stirred with an overhead mixer for 1 minute and then vacuum-filtered. Lastly, the sample was added to 1 L of 0.1M HCl solution and stirred using an overhead mixer for 2 minutes followed by vacuum filtration, and then dried overnight at 50°.

The final product was submitted ICP elemental analysis, which indicated the sample had approximately 0.38 weight % Ag.

### Example IV: Electroless Cu Deposition on Acid-Leached C-Glass

The material generated in the fourth example was generated as follows.

First, 15 g of glass microfibers (C-04-F from Unifrax) was added to 4 L of 5.5 weight % aqueous nitric acid solution and then heated to 90° C. for 2 hours. The acid-leached sample was then vacuum-filtered using a Buchner funnel, washed with 7.6 L of deionized water, and dried overnight at 110° C. The acid-leached sample was added to a solution containing 0.50 g of SnCl₂-2H₂O dissolved in 500 mL Millipore water along with one drop of concentrated HCl. After manually stirring for 2 minutes, the mixture was vacuum-filtered and washed with 150 mL of Millipore water. The resulting filter cake was then added to a solution containing 0.05 g AgNO₃ in 500 mL Millipore water and manually stirred for two minutes followed by vacuum-filtration, and then washed with 150 mL of Millipore water. The sample was then added to 500 mL of 12M HCl solution, manually stirred for two minutes and then vacuum-filtered and washed again.

A 58° C. water bath was set up. 1 L of Millipore water was combined with 40.0 g of EDTA and 10.7 g of tartaric acid and the pH was adjusted to 12.6 using KOH pellets, followed by addition of 0.745 g of CuSO₄-5H₂O. Separately, 148.8 g of glyoxylic acid solution (50 weight %) was combined with 1L of Millipore water and 92 g of KOH pellets to give a pH of 12.5. 670 mL and 330 mL portions of this solution were placed into separate beakers and heated to 58° C. in the water bath. The treated glass was added to the 670 mL portion, and while agitating with bubbling air, 100 mL aliquots of the CuSO₄ solution were added. The pH was monitored, and when it fell below 12, more KOH pellets were added to bring pH back to ˜12.5. After all the CuSO₄ solution had been added, the 330 mL portion of the glyoxylic acid solution was added, which changed the color of the solution from green to yellow. The resulting product was vacuum filtered, washed with 300 mL Millipore water, and dried overnight at 50° C.

The final product was submitted for ICP elemental analysis, which indicated the sample had approximately 0.68 weight % Cu and 0.24 weight % percent Ag. The antiviral properties of this material against MS2 Bacteriophage (ATCC 15597-B1) analyzed with AATCC study showed 99.98% reduction against control sample with 55.8% reduction.

### Example V: Biocidal Surrogate Testing

Biocidal surrogate testing of treated fibers was conducted using the following protocol: 0.5 gram of the fibers from Example II were placed in 80 ml glass jars. 1.0 ml of a culture of Serratia marcescens grown overnight in nutrient broth was then added to the fiber samples in the jars. The bacterial inoculum was allowed to contact the fibers for 4-hours. 10 ml aliquots of phosphate buffered saline (PBS) were added to the jars to wash the bacteria from the fiber. A total of 50 ml of PBS was added to the jars. 1.0 ml of the wash water was then serially diluted and 200 μl was withdrawn and dispensed onto nutrient agar plates. This aliquot was then spread over the surface of the plates. Untreated fiber was also tested as a control. After 4 hours of contact time, the bacteria colonies were counted, and it was observed that the Cu-plated sample from Example II showed no observable bacteria colonies, a 100% reduction compared to the control sample, which was determined to have 280,000 colony forming units (CFU). Hence, the biocidal surrogate experiment clearly demonstrates the efficacy of the metal deposition process for imparting the glass fibers with exceptional antimicrobial properties.

### Specific Embodiments

While the following is described in conjunction with specific embodiments, it will be understood that this description is intended to illustrate and not limit the scope of the preceding description and the appended claims.

A first embodiment of the invention is a process for increasing a viricidal activity of a fiber substrate, the process comprising: providing the fiber substrate; introducing the fiber substrate to a divalent metal solution to deposit divalent metals from the divalent metal solution on the fiber substrate; introducing the fiber substrate to an antiviral metal salt to form a treated fiber substrate in which antiviral metal from the antiviral metal salt is deposited on the fiber substrate by reduction as a result of oxidation of the divalent metals deposited on the fiber substrate; and, drying the treated fiber substrate; wherein the reduced antiviral metal is present on the treated fiber substrate in an amount between about 0.0001 wt. % and about 5.0 wt. % of the treated fiber substrate. An embodiment of the invention is one, any or all of prior embodiments in this paragraph up through the first embodiment in this paragraph, wherein the fiber substrate comprises fiberglass, cellulose, or a combination thereof. An embodiment of the invention is one, any or all of prior embodiments in this paragraph up through the first embodiment in this paragraph, wherein the divalent metal is selected from a group consisting of Sn²⁺, Ni²⁺, Co²⁺, Fe²⁺, and combinations thereof. An embodiment of the invention is one, any or all of prior embodiments in this paragraph up through the first embodiment in this paragraph, wherein the antiviral metal is selected from a group consisting of silver, copper, zinc, bismuth, nickel, tin, iron, and combinations thereof. An embodiment of the invention is one, any or all of prior embodiments in this paragraph up through the first embodiment in this paragraph, wherein an acid leaching step is performed prior to introducing the fiber substrate to the divalent metal solution, wherein the acid leaching step comprises an acid selected from a group consisting of a strong acid and a carboxylic acid. An embodiment of the invention is one, any or all of prior embodiments in this paragraph up through the first embodiment in this paragraph, further comprising an acid washing step wherein the treated fiber substrate is washed to remove a portion of metal that has been oxidized. An embodiment of the invention is one, any or all of prior embodiments in this paragraph up through the first embodiment in this paragraph, comprising a water washing step after the acid leaching step. An embodiment of the invention is one, any or all of prior embodiments in this paragraph up through the first embodiment in this paragraph, comprising a further water washing step after the treated substrate is formed. An embodiment of the invention is one, any or all of prior embodiments in this paragraph up through the first embodiment in this paragraph, wherein the fiber substrate comprises borosilicate glass. An embodiment of the invention is one, any or all of prior embodiments in this paragraph up through the first embodiment in this paragraph, wherein the antiviral metal is present in an amount between about 0.001 wt. % and about 2.5 wt. % of the treated fiber substrate. An embodiment of the invention is one, any or all of prior embodiments in this paragraph up through the first embodiment in this paragraph, wherein the antiviral metal is present in an amount between about 0.0001 wt. % and about 2.5 wt. % of the treated fiber substrate. An embodiment of the invention is one, any or all of prior embodiments in this paragraph up through the first embodiment in this paragraph, wherein the divalent metal salt solution is introduced to the fiber substrate by a paper-making process in one or more of the following unit operations wet-end mix tank, machine chest, headbox or binder impregnation section of a paper machine selected from the group consisting of fourdrinier, twin-wire machine, rotoformer, and deltaformer, or other inclined-type paper machines. An embodiment of the invention is one, any or all of prior embodiments in this paragraph up through the first embodiment in this paragraph, wherein the antiviral metal salt is introduced to the fiber substrate by a paper-making process in one or more of the following unit operations subsequent to introducing the divalent metal salt solution wet-end mix tank, machine chest, headbox or binder impregnation section of a paper machine selected from the group consisting of fourdrinier, twin-wire machine, rotoformer, deltaformer, or other inclined-type paper machines.

A second embodiment of the invention is a process for increasing a viricidal activity of a fiber substrate, the process comprising providing the fiber substrate; introducing the fiber substrate to a solution comprising a divalent metal salt; introducing the fiber substrate to a solution comprising a first antiviral metal salt, the first antiviral metal salt comprising a first antiviral metal; introducing a reducing agent; and introducing a second antiviral metal salt in an alkaline solution to form a treated fiber substrate, the second antiviral metal salt comprising a second antiviral metal; and wherein a viricidal activity of the treated fiber substate is higher than a viricidal activity of the fiber substrate, wherein the antiviral metal is present in an amount between about 0.0001 wt. % and about 5.0 wt. % of the treated fiber substrate. An embodiment of the invention is one, any or all of prior embodiments in this paragraph up through the second embodiment in this paragraph, wherein the alkaline solution further comprises a complexing agent. An embodiment of the invention is one, any or all of prior embodiments in this paragraph up through the second embodiment in this paragraph, wherein the reducing agent is selected from a group consisting of glyoxylic acid, oxalic acid, glycolic acids, glucose, formaldehyde, hydrazine, sodium borohydride, and combinations thereof. An embodiment of the invention is one, any or all of prior embodiments in this paragraph up through the second embodiment in this paragraph, wherein the first antiviral metal and the second antiviral metal are selected from a group consisting of silver, copper, zinc, bismuth, tin, nickel, and combinations thereof, and wherein the second antiviral metal is less noble than the first antiviral metal. An embodiment of the invention is one, any or all of prior embodiments in this paragraph up through the second embodiment in this paragraph, wherein the first and second antiviral metals are deposited in an amount between about 0.001 wt. % and about 2.5 wt. % of the treated fiber substrate. An embodiment of the invention is one, any or all of prior embodiments in this paragraph up through the second embodiment in this paragraph, comprising a further step of introducing the reducing agent after the step of introducing the second antiviral metal salt. An embodiment of the invention is one, any or all of prior embodiments in this paragraph up through the second embodiment in this paragraph, wherein the second antiviral metal is deposited on the fiber substrate by electroless deposition, and wherein the first antiviral metal is more noble than the second antiviral metal. An embodiment of the invention is one, any or all of prior embodiments in this paragraph up through the second embodiment in this paragraph, wherein at least one of the first and second antiviral metal salts is introduced to the fiber substrate by a paper-making process in one or more of the following unit operations wet-end mix tank, machine chest, headbox or binder impregnation section of a paper machine selected from the group consisting of fourdrinier, twin-wire machine, rotoformer, deltaformer, or other inclined-type paper machines.

A third embodiment of the invention is a filter media substrate having viricidal activity comprising the filter media substrate treated with one or more antiviral metals, wherein the filter media substrate comprises a fiber substrate; wherein the one or more antiviral metals are selected from the group consisting of silver, copper, zinc, bismuth, tin, nickel, iron, and combinations thereof; and wherein the one or more antiviral metals are present in an amount between about 0.0001 wt. % and about 5.0 wt. % of the filter media substrate. An embodiment of the invention is one, any or all of prior embodiments in this paragraph up through the third embodiment in this paragraph, wherein the one or more antiviral metals are present in an amount between about 0.001 wt. % and about 2.5 wt. % of the filter media substrate. An embodiment of the invention is one, any or all of prior embodiments in this paragraph up through the third embodiment in this paragraph, wherein the fiber substrate comprises cellulose, fiberglass, or combinations thereof. An embodiment of the invention is one, any or all of prior embodiments in this paragraph up through the third embodiment in this paragraph, wherein the one or more antiviral metals are introduced to the fiber substrate by a paper-making process in one or more of the following unit operations wet-end mix tank, machine chest, headbox or binder impregnation section of a paper machine selected from the group consisting of fourdrinier, twin-wire machine, rotoformer, deltaformer, or other inclined-type paper machines. An embodiment of the invention is one, any or all of prior embodiments in this paragraph up through the third embodiment in this paragraph, wherein the fiber substrate comprises borosilicate glass. An embodiment of the invention is one, any or all of prior embodiments in this paragraph up through the third embodiment in this paragraph, wherein the fiber substrate comprises fibers having the one or more antiviral metals, the one or more antiviral metals comprising silver, and the silver present on the fibers in a loading density range of about 0.0016 to about 80 atoms/nm². An embodiment of the invention is one, any or all of prior embodiments in this paragraph up through the third embodiment in this paragraph, wherein the silver is present on the fibers in a loading density range between about 0.016 and about 40 atoms/nm². An embodiment of the invention is one, any or all of prior embodiments in this paragraph up through the third embodiment in this paragraph, wherein the fiber substrate comprises fibers having the one or more antiviral metals, the one or more antiviral metals comprising copper, and the copper present in a loading density range between about 0.0027 and about 134 atoms/nm². An embodiment of the invention is one, any or all of prior embodiments in this paragraph up through the third embodiment in this paragraph, wherein the copper is present on the fibers in a loading density range between about 0.027 and about 67 atoms/nm².

A fourth embodiment of the invention is a filer media comprising a fiber substrate having an antiviral treatment, wherein the antiviral treatment comprises the steps of (a) providing the fiber substrate; (b) introducing the fiber substrate to a divalent metal solution; (c) introducing the fiber substrate to an antiviral metal salt to form a treated fiber substrate; and wherein an antiviral metal of the antiviral metal salt is reduced by a divalent metal of the divalent metal solution, and the divalent metal is oxidized; and wherein the antiviral metal is present in an amount ranging from about 0.0001 to about 5.0 wt. % of the antiviral fiber substrate. An embodiment of the invention is one, any or all of prior embodiments in this paragraph up through the fourth embodiment in this paragraph, wherein the fiber substrate comprises fiberglass, cellulose, or a combination thereof. An embodiment of the invention is one, any or all of prior embodiments in this paragraph up through the fourth embodiment in this paragraph, wherein the antiviral metal is selected from a group consisting of silver, copper, zinc, bismuth, nickel, tin, iron, and combinations thereof. An embodiment of the invention is one, any or all of prior embodiments in this paragraph up through the fourth embodiment in this paragraph, wherein the fiber substrate comprises fibers having the one or more antiviral metals, the one or more antiviral metals comprising silver, and the silver present on the fibers in a loading density range of about 0.0016 to about 80 atoms/nm². An embodiment of the invention is one, any or all of prior embodiments in this paragraph up through the fourth embodiment in this paragraph, wherein the silver is present on the fibers in a loading density range between about 0.016 and about 40 atoms/nm². An embodiment of the invention is one, any or all of prior embodiments in this paragraph up through the fourth embodiment in this paragraph, wherein the fiber substrate comprises fibers having the one or more antiviral metals, the one or more antiviral metals comprising copper, and the copper present in a loading density range between about 0.0027 and about 134 atoms/nm². An embodiment of the invention is one, any or all of prior embodiments in this paragraph up through the fourth embodiment in this paragraph, wherein the copper is present on the fibers in a loading density range between about 0.027 and about 67 atoms/nm². An embodiment of the invention is one, any or all of prior embodiments in this paragraph up through the fourth embodiment in this paragraph, wherein the fiber substrate comprises borosilicate glass.

A fifth embodiment of the invention is a filter media comprising a fiber substrate having an antiviral treatment, wherein the antiviral treatment comprises the steps of (a) providing the fiber substrate; (b) introducing the fiber substrate to a solution comprising a divalent metal salt; (c) introducing the fiber substrate to a solution comprising a first antiviral metal salt, the first antiviral metal salt comprising a first antiviral metal; (d) introducing a reducing agent; and (e) introducing a second antiviral metal salt in an alkaline solution to form a treated fiber substrate, the second antiviral metal salt comprising a second antiviral metal; and wherein a viricidal activity of the treated fiber substate is higher than a viricidal activity of the fiber substrate, and, wherein the antiviral metal is present in an amount ranging from about 0.0001 to about 5.0 wt. % of the antiviral fiber substrate. An embodiment of the invention is one, any or all of prior embodiments in this paragraph up through the fifth embodiment in this paragraph, wherein the fiber substrate comprises borosilicate glass. An embodiment of the invention is one, any or all of prior embodiments in this paragraph up through the fifth embodiment in this paragraph, wherein the first antiviral metal and the second antiviral metal are selected from a group consisting of silver, copper, zinc, bismuth, nickel, tin, iron, and combinations thereof. An embodiment of the invention is one, any or all of prior embodiments in this paragraph up through the fifth embodiment in this paragraph, wherein the fiber substrate comprises fibers having the one or more antiviral metals, the one or more antiviral metals comprising silver, and the silver present on the fibers in a loading density range of about 0.0016 to about 80 atoms/nm². An embodiment of the invention is one, any or all of prior embodiments in this paragraph up through the fifth embodiment in this paragraph, wherein the silver is present on the fibers in a loading density range between about 0.016 and about 40 atoms/nm². An embodiment of the invention is one, any or all of prior embodiments in this paragraph up through the fifth embodiment in this paragraph, wherein the fiber substrate comprises fibers having the one or more antiviral metals, the one or more antiviral metals comprising copper, and the copper present in a loading density range between about 0.0027 and about 134 atoms/nm². An embodiment of the invention is one, any or all of prior embodiments in this paragraph up through the fifth embodiment in this paragraph, wherein the copper is present on the fibers in a loading density range between about 0.027 and about 67 atoms/nm².

A sixth embodiment of the invention is a process for increasing a viricidal activity of a fiber substrate, the process comprising providing the fiber substrate; introducing the fiber substrate to a divalent metal solution to deposit divalent metals from the divalent metal solution on the fiber substrate; introducing the fiber substrate to an antiviral metal salt to form a treated fiber substrate in which antiviral metal from the antiviral metal salt is deposited on the fiber substrate by reduction as a result of oxidation of the divalent metals deposited on the fiber substrate; and, drying the treated fiber substrate; wherein the reduced antiviral metal is present on the treated fiber substrate in an amount between about 0.0001 wt. % and about 5.0 wt. % of the treated fiber substrate. An embodiment of the invention is one, any or all of prior embodiments in this paragraph up through the sixth embodiment in this paragraph, wherein the fiber substrate comprises fiberglass, cellulose, or a combination thereof. An embodiment of the invention is one, any or all of prior embodiments in this paragraph up through the sixth embodiment in this paragraph, wherein the divalent metal is selected from a group consisting of Sn²⁺, Ni²⁺, Co²⁺, Fe²⁺, and combinations thereof. An embodiment of the invention is one, any or all of prior embodiments in this paragraph up through the sixth embodiment in this paragraph, wherein the antiviral metal is selected from a group consisting of silver, copper, zinc, bismuth, nickel, tin, iron, and combinations thereof. An embodiment of the invention is one, any or all of prior embodiments in this paragraph up through the sixth embodiment in this paragraph, wherein an acid leaching step is performed prior to introducing the fiber substrate to the divalent metal solution, wherein the acid leaching step comprises an acid selected from a group consisting of a strong acid and a carboxylic acid. An embodiment of the invention is one, any or all of prior embodiments in this paragraph up through the sixth embodiment in this paragraph, comprising a water washing step after the acid leaching step. An embodiment of the invention is one, any or all of prior embodiments in this paragraph up through the sixth embodiment in this paragraph, further comprising an acid washing step wherein the treated fiber substrate is washed to remove a portion of metal that has been oxidized.

An embodiment of the invention is one, any or all of prior embodiments in this paragraph up through the sixth embodiment in this paragraph, wherein the antiviral metal is present in an amount between about 0.001 wt. % and about 2.5 wt. % of the treated fiber substrate. An embodiment of the invention is one, any or all of prior embodiments in this paragraph up through the sixth embodiment in this paragraph, wherein the antiviral metal is present in an amount between about 0.0001 wt. % and about 2.5 wt. % of the treated fiber substrate. An embodiment of the invention is one, any or all of prior embodiments in this paragraph up through the sixth embodiment in this paragraph, wherein the divalent metal salt solution is introduced to the fiber substrate by a paper-making process in one or more of the following unit operations wet-end mix tank, machine chest, headbox or binder impregnation section of a paper machine selected from the group consisting of fourdrinier, twin-wire machine, rotoformer, and deltaformer, or other inclined-type paper machines. An embodiment of the invention is one, any or all of prior embodiments in this paragraph up through the sixth embodiment in this paragraph, wherein the antiviral metal salt is introduced to the fiber substrate by a paper-making process in one or more of the following unit operations subsequent to introducing the divalent metal salt solution wet-end mix tank, machine chest, headbox or binder impregnation section of a paper machine selected from the group consisting of fourdrinier, twin-wire machine, rotoformer, deltaformer, or other inclined-type paper machines. An embodiment of the invention is one, any or all of prior embodiments in this paragraph up through the sixth embodiment in this paragraph, further comprising introducing a reducing agent with the antiviral metal salt. An embodiment of the invention is one, any or all of prior embodiments in this paragraph up through the sixth embodiment in this paragraph, wherein the reducing agent is selected from a group consisting of glyoxylic acid, oxalic acid, glycolic acids, glucose, formaldehyde, hydrazine, sodium borohydride, and combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for increasing a viricidal activity of a fiber substrate, the process comprising:
providing the fiber substrate;
introducing the fiber substrate to a divalent metal solution to deposit divalent metals from the divalent metal solution on the fiber substrate;
introducing the fiber substrate to an antiviral metal salt to form a treated fiber substrate in which antiviral metal from the antiviral metal salt is deposited on the fiber substrate by reduction as a result of oxidation of the divalent metals deposited on the fiber substrate; and,
drying the treated fiber substrate;
wherein the reduced antiviral metal is present on the treated fiber substrate in an amount between about 0.0001 wt. % and about 5.0 wt. % of the treated fiber substrate.

2. The process of claim 1, wherein the fiber substrate comprises fiberglass, cellulose, or a combination thereof.

3. The process of claim 1, wherein the divalent metal is selected from a group consisting of: Sn²⁺, Ni²⁺, Co²⁺, Fe²⁺, and combinations thereof.

4. The process of claim 1, wherein the antiviral metal is selected from a group consisting of: silver, copper, zinc, bismuth, nickel, tin, iron, and combinations thereof.

5. The process of claim 1, wherein an acid leaching step is performed prior to introducing the fiber substrate to the divalent metal solution, wherein the acid leaching step comprises an acid selected from a group consisting of: a strong acid and a carboxylic acid.

6. The process of claim 5, comprising a water washing step after the acid leaching step.

7. The process of claim 1, further comprising an acid washing step wherein the treated fiber substrate is washed to remove a portion of metal that has been oxidized.

8. The process of claim 1, wherein the antiviral metal is present in an amount between about 0.001 wt. % and about 2.5 wt. % of the treated fiber substrate.

9. The process of claim 8, wherein the antiviral metal is present in an amount between about 0.0001 wt. % and about 2.5 wt. % of the treated fiber substrate.

10. The process of claim 1, wherein the divalent metal salt solution is introduced to the fiber substrate by a paper-making process in one or more of the following unit operations: wet-end mix tank, machine chest, headbox or binder impregnation section of a paper machine selected from the group consisting of: fourdrinier, twin-wire machine, rotoformer, and deltaformer, or other inclined-type paper machines.

11. The process of claim 1, wherein the antiviral metal salt is introduced to the fiber substrate by a paper-making process in one or more of the following unit operations subsequent to introducing the divalent metal salt solution: wet-end mix tank, machine chest, headbox or binder impregnation section of a paper machine selected from the group consisting of: fourdrinier, twin-wire machine, rotoformer, deltaformer, or other inclined-type paper machines.

12. The process of claim 1, further comprising:
introducing a reducing agent with the antiviral metal salt.

13. The process of claim 12, wherein the reducing agent is selected from a group consisting of glyoxylic acid, oxalic acid, glycolic acids, glucose, formaldehyde, hydrazine, sodium borohydride, and combinations thereof.

14. A filter media substrate having viricidal activity comprising:
the filter media substrate treated with one or more antiviral metals, wherein the filter media substrate comprises a fiber substrate;
wherein the one or more antiviral metals are selected from the group consisting of silver, copper, zinc, bismuth, tin, nickel, iron, and combinations thereof; and
wherein the one or more antiviral metals are present in an amount between about 0.0001 wt. % and about 5.0 wt. % of the filter media substrate.

15. The filter media substrate of claim 14, wherein the one or more antiviral metals are present in an amount between about 0.001 wt. % and about 2.5 wt. % of the filter media substrate.

16. The filter media substrate of claim 14, wherein the fiber substrate comprises cellulose, fiberglass, or combinations thereof.

17. The filter media substrate of claim 14, wherein the fiber substrate comprises fibers having the one or more antiviral metals, the one or more antiviral metals comprising silver, and the silver present on said fibers in a loading density range of about 0.0016 to about 80 atoms/nm².

18. The filter media substrate of claim 17, wherein the silver is present on said fibers in a loading density range between about 0.016 and about 40 atoms/nm².

19. The filter media substrate of claim 14, wherein the fiber substrate comprises fibers having the one or more antiviral metals, the one or more antiviral metals comprising copper, and the copper present in a loading density range between about 0.0027 and about 134 atoms/nm².

20. The filter media substrate of claim 19, wherein the copper is present on said fibers in a loading density range between about 0.027 and about 67 atoms/nm².
